(19) United States
(12) Patent Application Publication
(10) Pub. No.: US 2014/0167573 A1
(43) Pub. Date: Jun. 19, 2014

(54) MOTOR DRIVE FOR ACTUATING A STEP SWITCH

(71) Applicants: Alfred Bieringer, Geiselhoering (DE); Marco Hechtl, Pfreimd (DE); Mario Schmeckebier, Regensburg (DE)

(72) Inventors: Alfred Bieringer, Geiselhoering (DE); Marco Hechtl, Pfreimd (DE); Mario Schmeckebier, Regensburg (DE)

(21) Appl. No.: 14/235,131

(22) PCT Filed: Aug. 9, 2012
(86) PCT No.: PCT/EP2012/065600

§ 371 Date: Feb. 7, 2014

(30) Foreign Application Priority Data
Sep. 7, 2011 (DE) 102011112748.1

(51) Int. Cl. H02K 11/00; H02K 7/116; H02K 7/10

(52) U.S. Cl. CPC H02K 11/0042; H02K 7/1004; H02K 7/1166
USPC 310/68 B

(57) ABSTRACT

The invention relates to a motor drive for actuating a step switch, consisting of a drive motor, a load transmission, and a control transmission. Means for detecting a torque are provided in the housing of the motor drive, said means consisting of a radio-requestable surface wave sensor, a rotor antenna, and a stator antenna.

The invention relates to a motor drive for actuating a tap changer with means for torque detection.

It is already known from published specification DE 19744465 [US 20120169350] that there is a very substantial interest in monitoring tap changers during the entire period of a load changeover so as to be able to ensure correct functioning. This is usually realized by detection of the torque plot, positional detection of the respective instantaneous setting of a tap changer and comparison of the ascertained value pairs with previously stored values. The torque plot is in that case ascertained in each load changeover with the help of the effective values of current and voltage by way of the effective power of the drive.

Usually an electric motor drives the tap changer by way of a load transmission, a bevel gear transmission and a worm transmission. These transmissions are connected together by shafts and have different translation ratios and levels of efficiency. The two factors have an influence on the measured torque plot.

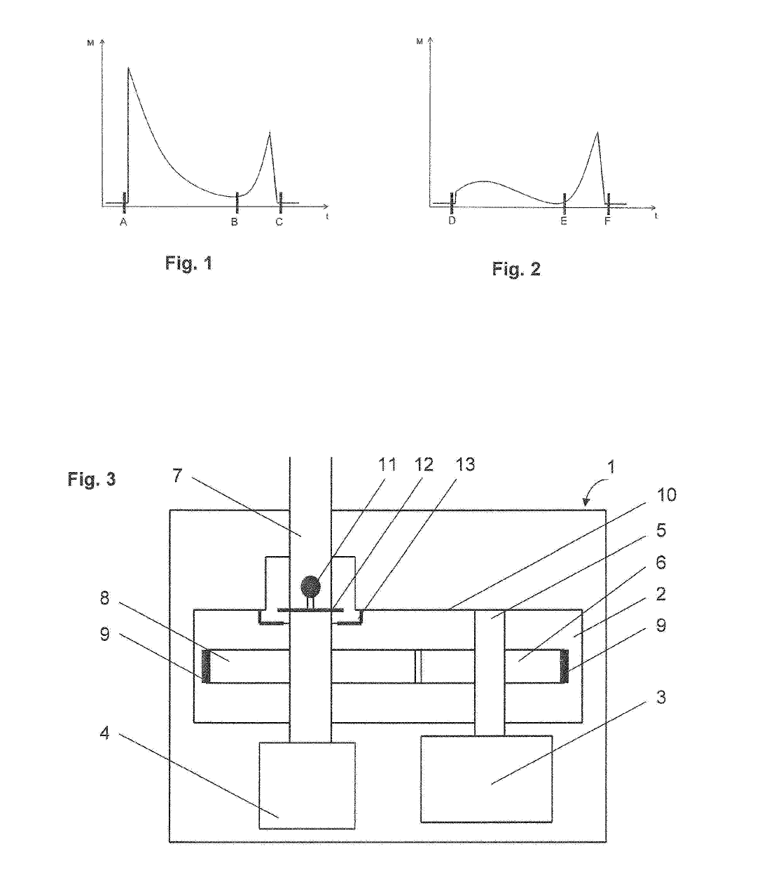

Temperature has a particularly significant influence on the efficiency of the load transmission. Since this is constructed as a belt transmission, there is the consequence at high temperatures that the belt slips, efficiency reduces and the torque plot is falsified. The belt transmission represents a substantial source of error also at operating temperatures below 0° Celsius. FIG. 1 shows a simplified, typical torque plot, measured at the motor drive of a first switching process at −20° Celsius. The abscissa depicts time t and the ordinate depicts torque M. Time instant A characterizes the start of the switching process. The torque initially strongly rises from this time instant. This is primarily attributable to the fact that the belt of the transmission is very cold and is tough at low temperature and the motor initially has to overcome this resistance. In addition, the lubricants in the worm transmission and bevel gear transmission form a resistance at these temperatures; this is very small by comparison with that of the belt. After overcoming the first resistances the torque drops until the time instant B. Between the time instants B and C the torque plot rises for the second time. In that case, however, this does not reach the same value as at the start of the switching process. This rise is attributable to the fact that the energy store shortly before triggering needs more is energy for the final stressing of the springs. After release of the energy store and the changeover process connected therewith torque drops until the time instant C that represents the end of the switching process.

Whereas the second rise that is caused by the energy store, is characteristic for the torque plot of a changeover process, the first rise, between the time instants A and B, is always temperature-dependent and thus non-constant and not calculable. This can be seen particularly clearly in FIG. 2. Here the measured torque plot is shown after 30 successive switching processes. The error of the first, strongly pronounced rise of the torque between the time instants D and E can be readily ascertained. This is primarily attributable to the fact that the belt of the load transmission has reached an operating temperature and thus needs less power from the drive that is in turn reflected in the torque plot. It can also be clearly seen that the plots of the curves between the time instants E and F are comparable with those between B and C. It can thus be established that temperature fluctuations have a small influence on the energy store.

In order to be able to ascertain functional disturbances such as, for example, breakage of a shaft or of a component in the energy store, limit values are assigned to the individual time segments. Exceeding of these limit values is interpreted as a fault. Due to the strong fluctuations at the start of the switching processes the limit values have to be set very high so that the first switching processes are not classified as faulty. However, as soon as all components have reached an operating temperature the limit value is too high, so that faults below the limit values are no longer detectable.

It is also disadvantageous in the prior art that all transmissions incorporated in the drive unit have an influence on the measurement error. These are determined by the products of the individual efficiencies and translation ratios and can strongly fluctuate in the case of temperature changes. This applies particularly to the values of the load transmission.

A further source of error in the determination of the torque plot by way of the effective power of the drive is represented by the drive itself. Since the individual parts of this drive can be procured on a worldwide basis, the manufacturers cannot supply apparatus with constant parameter values.

Thus, these fluctuations also have to be taken into consideration so as to be able to ensure accurate measurement results.

The object of the invention is to provide a motor drive with means for torque detection, wherein the torque detection functions reliably, delivers more accurate measurement results and takes into consideration temperature influence so as to thereby eliminate the factors of the load transmission contributing to measurement error.

The object is fulfilled by a motor drive with means for torque detection for a tap changer with the features of the first claim.

The invention is generally based on the idea of arranging the torque detection closer to the tap changer, to make the is measurements independent of temperature and to exclude load transmission factors.

The invention shall be explained in the following by way of figures, in which:

FIG. 1 shows a typical torque plot at a motor drive in a switching process at −20° C. after a longer period of standstill,

FIG. 2 shows a typical torque plot at a motor drive in a switching process at −20° C. after 30 switching processes, and

FIG. 3 shows a motor drive according to the invention with a load transmission, control transmission, drive motor and means for torque detection.

A motor drive 1 with a load transmission 2, a drive motor 3 and a control transmission 4 is illustrated in FIG. 3. A first drive shaft 5 that is driven by the drive motor 3 and that is mechanically connected with a first drive pulley 6, is present in the interior of the load transmission 2. Moreover, a second drive shaft 7 that is mechanically connected with a second drive pulley 8, is similarly present in the interior of the load transmission 2. The second drive pulley 7 additionally drives the control transmission 4 and a tap changer (not illustrated here). The drive shaft 7 is connected with the tap changer by way of a drive train (similarly not illustrated here).

The drive pulleys 6, 8 are connected by way of a belt 9 so that transmission of rotational movement, emanating from the drive motor 3, is achieved. The means (not illustrated) necessary for mounting the drive shafts 5, 7, for example ball-bearings, are mounted at the housing 10 or integrated therewith.

At least one surface-wave sensor 11 capable of interrogation by radio is mounted on the second drive shaft 7. This sensor is a so-called surface-wave sensor (SAW sensor) interrogatable by radio. The surface-wave sensor 11 interrogatable by radio is conductively connected with a rotor antenna 12. This is of radial construction and mechanically connected with the drive shaft 7. An axially spaced, disc-shaped stator antenna 13 of radial construction is arranged with respect to the rotor antenna 12. The stator antenna 13 is fixedly located in the housing 10. Energy and data transmission takes place electromagnetically by way of the rotor antenna 12 and the stator antenna 13.

The exclusion of the load transmission from the measurements of the torque plot is particularly advantageous. Measurement at the output of the load transmission enables more precise fault analyses that are less able to be influenced by temperatures. In addition, the factors of efficiency and translation ratio of the load transmission that have an influence on the measurement error, are eliminated. In addition, the error factor of motor no longer needs to be taken into consideration. Moreover, tolerances changing with time, as well as wear of mechanical parts of the load transmission, do not have to be taken into consideration. The contactless energy and data transmission is almost maintenance-free by comparison with wiping contacts or direct connections.

In addition, it is also possible to detect the temperature of the drive shaft 7 by the surface-wave sensor 11 interrogatable by radio. The measurement values of the torque plot can thereby be corrected by a temperature-dependent factor. More accurate values are obtained and consequently a greater degree of reliability in the monitoring of load changeover processes.

### REFERENCE NUMERAL LIST

1 motor drive
2 load transmission
3 drive motor
4 control transmission
5 drive shaft
6 drive pulley
7 drive shaft
8 drive pulley
9 belt
10 housing
11 surface-wave sensor interrogatable by radio
12 rotor antenna
13 stator antenna

1. (canceled)

2. The motor drive for actuating a tap changer according to claim 5, wherein the load transmission (2) is a bevel gear transmission, worm transmission or gear transmission.

3. The motor drive for actuating a tap changer according to claim 5, wherein energy and data transmission takes place electromagnetically by way of the rotor antenna and the stator antenna in such that it can be contactlessly coupled into the at least one surface-wave sensor.

4. The motor drive for actuating a tap changer according to any one of claims 5, wherein the at least one surface-wave sensor also detects temperature.

5. A motor drive for actuating a tap changer, the drive comprising:
a drive motor;
a housing;
a load transmission in the housing, driven by the drive motor, and having a first drive shaft carrying a first drive pulley connected with the drive motor and a second drive shaft carrying a second drive pulley;
a belt interconnecting the first and second drive pulleys;
a control transmission;
a drive chain connected with the control transmission between the tap changer and the second drive pulley;
at least one surface-wave sensor in the housing, interrogatable by radio, and attached to the second drive shaft,
a rotor antenna in the housing, conductively connected with the surface-wave sensor, and attached to the second drive shaft;
a stator antenna fixed in the housing and axially spaced from the rotor antenna.

6. The motor drive for actuating a tap changer according to claim 5, wherein the stator antenna is of disc-shaped radial construction and is radially spaced from the rotor antenna.
